(19) United States
(12) Patent Application Publication
(10) Pub. No.: US 2007/0069424 A1
(43) Pub. Date: Mar. 29, 2007

(54) Reaction injection molding assembly for manufacturing a golf ball component

(76) Inventors: Thomas A. Veilleux, Charlton, MA (US); David M. Melanson, Northampton, MA (US); Thomas R. Bergin, Holyoke, MA (US)

Correspondence Address: MICHAEL A. CATANIA;CALLAWAY GOLF COMPANY, 2180 RUTHERFORD ROAD, CARLSBAD, CA, 92008-7328, US

(21) Appl. No.: 11/216,252

(22) Filed: Aug. 30, 2005

(51) Int. Cl. B29C 45/14

(52) U.S. Cl. 264/328.6; 264/279; 264/279.1; 425/542; 425/205

(57) ABSTRACT

A molding assembly and related process are described that eliminate or significantly reduce cosmetic defects otherwise occurring in golf balls. The assembly includes molds with particular runner configurations, gate configurations, and venting characteristics. The assemblies and processes described herein are particularly well suited for reaction injection molding of golf balls.

### CROSS REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to manufacturing golf balls. More specifically, the present invention relates to a manufacturing golf balls utilizing reaction injection molding.

2. Description of the Related Art

Golf balls are typically made today by molding a core of elastomeric or polymeric material into a spheroid shape. A cover is then molded around the core. Sometimes, before the cover is molded about the core, an intermediate layer is molded about the core and the cover is then molded around the intermediate layer. The molding processes used for the cover and the intermediate layer are similar and usually involve either compression molding or injection molding.

More particularly, in compression molding processes, the golf ball core is inserted into a central area of a two piece die and pre-sized sections of cover material are placed in each half of the die, which then clamps shut. The application of heat and pressure molds the cover material about the core.

Blends of polymeric materials have been used for modem golf ball covers. Some of these materials facilitate processing by compression molding, yet disadvantages have arisen. These disadvantages include, among others, the presence of seams in the cover, which occur where the pre-sized sections of cover material were joined, and high process cycle times which are required to heat the cover material and complete the molding process.

Injection molding of golf ball covers arose as a processing technique to overcome some of the disadvantages of compression molding. The process involves inserting a golf ball core into a die, closing the die and forcing a heated, viscous polymeric material into the die. The material is then cooled and the golf ball is removed from the die. Injection molding is well-suited for thermoplastic materials, but has limited application to some thermosetting polymers. However, certain types of these thermosetting polymers often exhibit the hardness and elasticity desired for a golf ball cover. Some of the most promising thermosetting materials are reactive, requiring two or more components to be mixed and rapidly transferred into a die before a polymerization reaction is complete. As a result, traditional injection molding techniques do not provide proper processing when applied to these materials.

Reaction injection molding is a processing technique used specifically for certain reactive thermosetting plastics. As mentioned above, by “reactive” it is meant that the polymer is formed from two or more components which react. Generally, the components, prior to reacting, exhibit relatively low viscosities. The low viscosities of the components allow the use of lower temperatures and pressures than those utilized in traditional injection molding. In reaction injection molding, the two or more components are combined and react to produce the final polymerized material. Mixing of these separate components is critical, a distinct difference from traditional injection molding.

The process of reaction injection molding a golf ball cover involves placing a golf ball core into a die, closing the die, injecting the reactive components into a mixing chamber where they combine, and transferring the combined material into the die. The mixing begins the polymerization reaction which is typically completed upon cooling of the cover material. Although satisfactory in certain respects, golf balls produced by current molding techniques frequently suffer from a variety of cosmetic defects. Accordingly, there remains a need to investigate the causes of such defects and provide solutions to avoid those defects.

### BRIEF SUMMARY OF THE INVENTION

The exemplary embodiments disclosed below provide new mold configurations, assemblies and processes which eliminate the occurrence of many types of cosmetic defects otherwise occurring on golf balls.

In one aspect, the exemplary embodiment provides a reaction injection molding assembly adapted for molding golf balls. The assembly comprises a molding member defining an inlet, a hollow molding chamber sized to receive a golf ball core or intermediate golf ball assembly, a diverging fan gate in communication with the molding chamber and disposed upstream thereof, the fan gate defining a cross-sectional area and a flow length, and a flow channel providing communication between the inlet and the fan gate. The cross-sectional area of the fan gate is constant or at least substantially so across the flow length of the fan gate.

In another aspect, the exemplary embodiment provides a reaction injection molding assembly adapted for molding golf balls. The assembly comprises a molding member defining an inlet for receiving flowing molding material, a first hollow molding chamber sized to receive a golf ball, a second hollow molding chamber sized to receive a golf ball, and a collection of flow channels providing flow communication between the inlet and both of the first molding chamber and the second molding chamber. The collection of flow channels includes a primary runner having a first cross-sectional area, and secondary runners both downstream of the primary runner. The secondary runners include a first secondary runner having a second cross-sectional area and a second secondary runner having a third cross-sectional area. The first cross-sectional area of the primary runner equals, or is at least substantially equal to, the sum of the second cross-sectional area of the first secondary runner and the third cross-sectional area of the second secondary runner.

In a further aspect, the exemplary embodiment provides a reaction injection molding assembly adapted for molding golf balls. The assembly comprises a molding member defining an inlet, a hollow molding chamber sized to receive a golf ball core or intermediate golf ball assembly, a fan gate in communication with the molding chamber and disposed upstream thereof, and a flow channel providing communication between the inlet and the fan gate. The fan gate intersects the molding chamber to thereby define a material flow front included angle ranging from about 5 degrees to about 180 degrees.

In other aspects, the exemplary embodiment provides related processes and golf balls produced by the processes.

One advantage of the exemplary embodiment is that the constituent materials are mixed thoroughly, thereby providing a more consistent intermediate and/or cover layer, resulting in better golf ball performance characteristics.

Another advantage of the exemplary embodiment is that the use of new, lower viscosity materials may be explored, resulting in enhanced golf ball properties and performance.

Yet another advantage of the exemplary embodiment is that increased mixing of lower viscosity materials allows the intermediate layer or cover to be thinner, resulting in increased ball performance.

Still another advantage of the exemplary embodiment is that a unique venting configuration of the mold reduces the porosity of the material being processed, creating a ball cover or other layer that is substantially free from voids.

A further advantage of the exemplary embodiment relates to the elimination of many forms of cosmetic defects that otherwise occur as a result of conventional molding equipment and techniques.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a schematic cross-sectional view of a first embodiment of a golf ball formed according to a reaction injection molded (RIM) process according to the exemplary embodiment.

FIG. 2 is a schematic cross-sectional view of a second embodiment of a golf ball formed according to a reaction injection molded (RIM) process according to the exemplary embodiment.

FIG. 3 is a schematic cross-sectional view of a third embodiment of a golf ball formed according to a reaction injection molded (RIM) process according to the exemplary embodiment.

FIG. 4 is a process flow diagram which schematically depicts a reaction injection molding process according to the exemplary embodiment.

FIG. 5 schematically shows a mold for reaction injection molding a golf ball cover according to the exemplary embodiment.

FIG. 6 is a perspective view revealing the components of a preferred embodiment golf ball in accordance with the exemplary embodiment.

FIG. 7 is a perspective view of a preferred embodiment of a molding assembly in accordance with the exemplary embodiment.

FIG. 8 is a planar view of a portion of the preferred embodiment molding assembly taken along line 3-3 in FIG. 7.

FIG. 9 is a planar view of a portion of the preferred embodiment molding assembly taken along line 4-4 in FIG. 7.

FIG. 10 is a detailed perspective view of a portion of the preferred embodiment molding assembly taken along line 5-5 in FIG. 7.

FIG. 11 is a detailed view of a nozzle block and a peanut or after-mixer of the preferred embodiment molding assembly in accordance with the exemplary embodiment.

FIG. 12 is a planar view of a portion of an alternative embodiment of the molding assembly in accordance with the exemplary embodiment.

FIG. 13 is a planar view of a portion of an alternative embodiment of the molding assembly in accordance with the exemplary embodiment.

FIG. 14 is a planar view of a portion of an alternative embodiment of the molding assembly in accordance with the exemplary embodiment.

FIG. 15 is a flow chart illustrating a preferred embodiment process in accordance with the exemplary embodiment.

FIG. 16 is a schematic planar view of a multi-array golf ball mold according to the exemplary embodiment.

FIG. 17 illustrates a golf ball disposed within a molding cavity in accordance with the exemplary embodiment.

FIG. 18 is a perspective view of the golf ball and cavity of FIG. 17.

FIG. 19 is a detailed view of the golf ball and cavity configuration of FIGS. 17 and 18.

FIG. 20 is a perspective view of a first mold in accordance with the exemplary embodiment.

FIG. 21 is a perspective view of a second mold in accordance with the exemplary embodiment.

FIG. 22 is a perspective view of the first and second molds of FIGS. 20 and 21 in engagement.

### DETAILED DESCRIPTION OF THE INVENTION

The exemplary embodiments provide a new mold or die configuration and a new method of processing for reaction injection molding a golf ball cover or inner layer which significantly reduces cosmetic defects and promotes increased mixing of constituent materials, resulting in enhanced properties and the ability to explore the use of materials new to the golf ball art.

A preferred embodiment of the exemplary embodiment is a golf ball in which at least one cover or core layer comprises a fast-chemical-reaction-produced component. This component includes at least one material selected from the group consisting of polyurethane, polyurea, polyurethane ionomer, epoxy, and unsaturated polyesters, and preferably comprises polyurethane. The exemplary embodiment also includes a method of producing a golf ball which contains a fast-chemical-reaction-produced component. A golf ball formed according to the exemplary embodiment preferably has a flex modulus in the range of from about 1 to about 310 kpsi, a Shore D hardness in the range of from about 10 to about 95, and good durability. Particularly preferred forms of the exemplary embodiment also provide for a golf ball with a fast-chemical-reaction-produced cover having good scuff resistance and cut resistance. The exemplary embodiment also provides molding equipment configured to eliminate or significantly reduce the occurrence of cosmetic defects otherwise occurring in molded golf balls.

Polyurethane and/or polyurea polymers are typically made from three reactants: alcohols, amines, and isocyanate-containing compounds. Both alcohols and amines have a reactive hydrogen atom and are generally referred to as “polyols”. They react with the isocyanate-containing compound, which is generally referred to as an “isocyanate.”

Several chemical reactions may occur during polymerization of isocyanate and polyol. Isocyanate groups (—N═C═O) that react with alcohols form a polyurethane, whereas isocyanate groups that react with an amine group form a polyurea. A polyurethane itself may react with an isocyanate to form an allophanate and a polyurea can react with an isocyanate to form a biuret. Because the biuret and allophanate reactions occur on an already-substituted nitrogen atom of the polyurethane or polyurea, these reactions increase cross-linking within the polymer.

As used herein, “polyurethane and/or polyurea” is expressed as “polyurethane/polyurea” or “polyurethane”.

The method of the exemplary embodiment is particularly useful in forming golf balls because it can be practiced at relatively low temperatures and pressures. The preferred temperature range for the preferred method of the exemplary embodiment is from about 90 to about 180° F. when the component being produced contains polyurethane. Preferred pressures for practicing the exemplary embodiment using polyurethane-containing materials are 200 psi or less and more preferably 100 psi or less. The method of the exemplary embodiment offers numerous advantages over conventional slow-reactive process compression molding of golf ball covers.

The method of the exemplary embodiment results in molded covers in a mold release or demold time of 10 minutes or less, preferably 2 minutes or less, and most preferably in 1 minute or less. The method of the exemplary embodiment results in the formation of a reaction product, formed by mixing two or more reactants together, that exhibits a reaction time of about 2 minutes or less, preferably 1 minute or less, and most preferably about 30 seconds or less.

The term “demold time” generally refers to the mold release time, which is the time span from the mixing of the components until the earliest possible removal of the finished part, sometimes referred to in the industry as “green strength.” The term “green strength” is sometimes used in the industry to refer to a time at which a molded part or component is strong enough to withstand removal from the mold without damage. The term “reaction time” generally refers to the setting time or curing time, which is the time span from the beginning of mixing until a point is reached where the polyaddition product no longer flows. Further description of the terms “setting time” and “mold release time” are provided in the “Polyurethane Handbook,” Edited by Günter Oertel, Second Edition, ISBN 1-56990-157-0, herein incorporated by reference.

The method of the exemplary embodiment is also particularly effective when recycled polyurethane or other polymer resin, or materials derived by recycling polyurethane or other polymer resin, are incorporated into the product. The process may include the step of recycling at least a portion of the reaction product, preferably by glycolysis. 5-100% of the polyurethane/polyurea formed from the reactants used to form particular components is obtained from recycled polyurethane/polyurea.

As indicated above, the fast-chemical-reaction-produced component can be one or more cover and/or core layers of the ball. When a polyurethane cover is formed according to the exemplary embodiment, and is then covered with a polyurethane top coat, excellent adhesion can be obtained. The adhesion in this case is better than adhesion of a polyurethane coating to an ionomeric cover. This improved adhesion can result in the use of a thinner top coat, the elimination of a primer coat, and the use of a greater variety of golf ball printing inks beneath the top coat. These include but are not limited to typical inks such as one component polyurethane inks and two component polyurethane inks.

The preferred method of forming a fast-chemical-reaction-produced component for a golf ball according to the exemplary embodiment is by reaction injection molding (“RIM”) such as disclosed in U.S. Pat. No. 6,855,073 which is hereby incorporated by reference in its entirety. RIM is a process by which highly reactive liquids are injected into a closed mold, mixed usually by impingement and/or mechanical mixing in an in-line device such as a “peanut mixer”, where they polymerize primarily in the mold to form a coherent, one-piece molded article. The RIM processes usually involve a rapid reaction between one or more reactive components such as polyether- or polyester-polyol, polyamine, or other material with an active hydrogen, and one or more isocyanate—containing constituents, often in the presence of a catalyst. The constituents are stored in separate tanks prior to molding and may be first mixed in a mix head upstream of a mold and then injected into the mold. The liquid streams are metered in the desired weight to weight ratio and fed into an impingement mix head, with mixing occurring under high pressure, e.g., 1500 to 3000 psi. The liquid streams impinge upon each other in the mixing chamber of the mix head and the mixture is injected into the mold. One of the liquid streams typically contains a catalyst for the reaction. The constituents react rapidly after mixing to gel and form polyurethane polymers. Polyureas, epoxies, and various unsaturated polyesters also can be molded by RIM.

RIM differs from non-reaction injection molding in a number of ways. The main distinction is that in RIM a chemical reaction takes place in the mold to transform a monomer or adducts to polymers and the components are in liquid form. Thus, a RIM mold need not be made to withstand the pressures which occur in a conventional injection molding. In contrast, injection molding is conducted at high molding pressures in the mold cavity by melting a solid resin and conveying it into a mold, with the molten resin often being at about 150 to about 350° C. At this elevated temperature, the viscosity of the molten resin usually is in the range of 50,000 to about 1,000,000 centipoise, and is typically around 200,000 centipoise. In an injection molding process, the solidification of the resins occurs after about 10 to about 90 seconds, depending upon the size of the molded product, the temperature and heat transfer conditions, and the hardness of the injection molded material. Subsequently, the molded product is removed from the mold. There is no significant chemical reaction taking place in an injection molding process when the thermoplastic resin is introduced into the mold. In contrast, in a RIM process, the chemical reaction causes the material to set, typically in less than about 5 minutes, often in less than 2 minutes, preferably less than 1 minute, more preferably in less than 30 seconds, and in many cases in about 10 seconds or less.

If plastic products are produced by combining components that are preformed to some extent, subsequent failure can occur at a location on the cover which is along the seam or parting line of the mold. Failure can occur at this location because this interfacial region is intrinsically different from the remainder of the cover layer and can be weaker or more stressed. The exemplary embodiment is believed to provide for improved durability of a golf ball cover layer by providing a uniform or “seamless” cover in which the properties of the cover material in the region along the parting line are generally the same as the properties of the cover material at other locations on the cover, including at the poles. The improvement in durability is believed to be a result of the fact that the reaction mixture is distributed uniformly into a closed mold. This uniform distribution of the injected materials eliminates knit-lines and other molding deficiencies which can be caused by temperature difference and/or reaction difference in the injected materials. The process of the exemplary embodiment results in generally uniform molecular structure, density and stress distribution as compared to conventional injection-molding processes.

The fast-chemical-reaction-produced component has a flex modulus of 1 to 310 kpsi, more preferably 5 to 100 kpsi, and most preferably 5 to 80 kpsi. The subject component can be a cover with a flex modulus which is higher than that of the centermost component of the cores, as in a liquid center core and some solid center cores. Furthermore, the fast-chemical-reaction-produced component can be a cover with a flex modulus that is higher than that of the immediately underlying layer, as in the case of a wound core. The core can be one piece or multi-layer, each layer can be either foamed or unfoamed, and density adjusting fillers, including metals, can be used. The cover of the ball can be harder or softer than any particular core layer.

The fast-chemical-reaction-produced component can incorporate suitable additives and/or fillers. When the component is an outer cover layer, pigments or dyes, accelerators and UV stabilizers can be added. Examples of suitable optical brighteners which probably can be used include Uvitex and Eastobrite OB-1. An example of a suitable white pigment is titanium dioxide. Examples of suitable and UV light stabilizers are provided in U.S. Pat. No. 5,494,291 which is hereby incorporated by reference in its entirety. Fillers which can be incorporated into the fast-chemical-reaction-produced cover or core component include those listed herein. Furthermore, compatible polymeric materials can be added. For example, when the component comprises polyurethane and/or polyurea, such polymeric materials include polyurethane ionomers, polyamides, etc. A golf ball core layer formed from a fast-chemical-reaction-produced material according to the exemplary embodiment typically contains 0 to 20 weight percent of such filler material, and more preferably 1 to 15 weight percent. When the fast-chemical-reaction-produced component is a core, the additives typically are selected to control the density, hardness and/or COR.

A golf ball inner cover layer or mantle layer formed from a fast-chemical-reaction-produced material according to the exemplary embodiment typically contains 0 to 60 weight percent of filler material, more preferably 1 to 30 weight percent, and most preferably 1 to 20 weight percent.

A golf ball outer cover layer formed from a fast-chemical-reaction-produced material according to the exemplary embodiment typically contains 0 to 20 weight percent of filler material, more preferably 1 to 10 weight percent, and most preferably 1 to 5 weight percent. Catalysts can be added to the RIM polyurethane system starting materials as long as the catalysts generally do not react with the constituent with which they are combined. Suitable catalysts include those which are known to be useful with polyurethanes and polyureas.

The reaction mixture viscosity should be sufficiently low to ensure that the empty space in the mold is completely filled. The reactant materials generally are preheated to 90 to 165° F. before they are mixed. In most cases it is necessary to preheat the mold to, e.g., 100 to 180° F., to ensure proper injection viscosity.

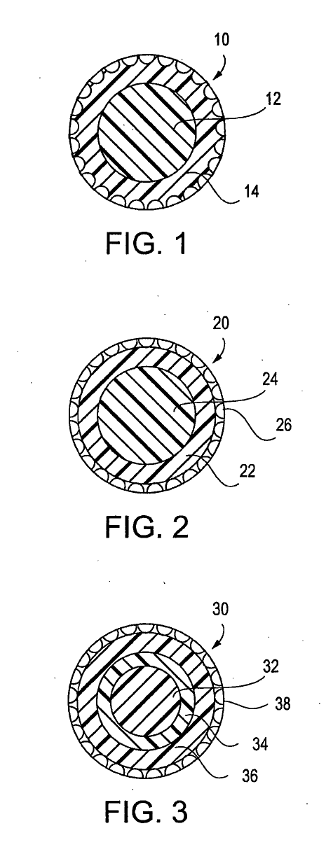

As indicated above, one or more cover layers of a golf ball can be formed from a fast-chemical-reaction-produced material according to the exemplary embodiment. Referring now to the drawings, and first to FIG. 1, a schematic cross-sectional view of a two-piece golf ball having a cover comprising a RIM polyurethane is shown. The golf ball 10 includes a polybutadiene core 12 and a polyurethane cover 14 formed by RIM.

Referring now to FIG. 2, a three-piece golf ball having a core comprising a RIM polyurethane is shown. The golf ball 20 has a RIM polyurethane core 24, and a RIM polyurethane layer 22 and an external cover 26, optionally formed from a RIM polyurethane. Referring to FIG. 3, a multi-layer golf ball 30 is shown with a solid core 32 containing recycled RIM polyurethane, a mantle cover layer 34 comprising RIM polyurethane, a second optional mantle layer 36, and an outer cover layer 38 comprising ionomer or another conventional golf ball cover material. Such conventional golf ball cover materials typically contain titanium dioxide utilized to make the cover white in appearance. Non-limiting examples of multi-layer golf balls according to the exemplary embodiment with two cover layers include those with RIM polyurethane mantles having a thickness of from about 0.01 to about 0.20 inches and a Shore D hardness of 10 to 95, covered with ionomeric or non-ionomeric thermoplastic, balata or other covers having a Shore D hardness of from about 10 to about 95 and a thickness of 0.020 to 0.100 inches.

Furthermore, a further preferred embodiment golf ball is a three-piece ball having a similar structure as that shown in FIG. 2 comprising a polybutadiene core, an ionomer mantle, and a RIM polyurethane cover. However, the exemplary embodiments include numerous other configurations and combinations of materials.

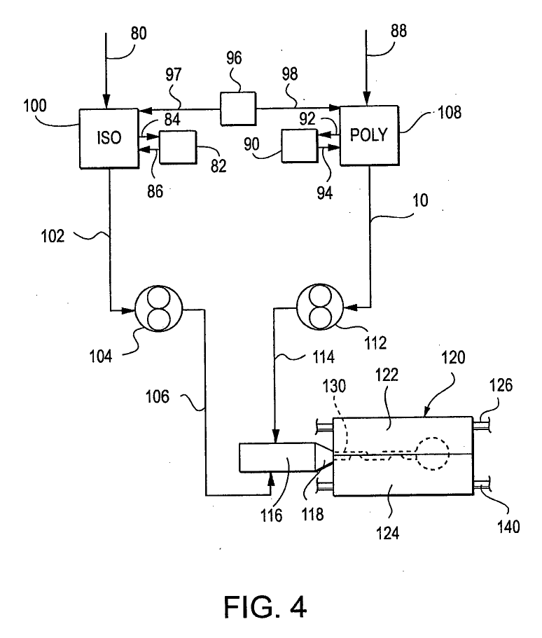

Referring next to FIG. 4, a process flow diagram for forming a RIM cover of polyurethane is shown. Isocyanate from bulk storage is fed through line 80 to an isocyanate tank 100. The isocyanate is heated to the desired temperature, e.g. 90 to about 165° F., by circulating it through heat exchanger 82 via lines 84 and 86. Polyol, polyamine, or another compound with an active hydrogen atom is conveyed from bulk storage to a polyol tank 108 via line 88. The polyol is heated to the desired temperature, e.g. 90 to about 165° F., by circulating it through heat exchanger 90 via lines 92 and 94. Dry nitrogen gas is fed from nitrogen tank 96 to isocyanate tank 100 via line 97 and to polyol tank 108 via line 98. Isocyanate is fed from isocyanate tank 100 via line 102 through a metering cylinder or metering pump 104 into recirculation mix head inlet line 106. Polyol is fed from polyol tank 108 via line 110 through a metering cylinder or metering pump 112 into a recirculation mix head inlet line 114. The recirculation mix head 116 receives isocyanate and polyol, mixes them, and provides for them to be fed through nozzle 118 into injection mold 120. The injection mold 120 has a top mold 122 and a bottom mold 124. Mold heating or cooling can be performed through lines 126 in the top mold 122 and lines 140 in the bottom mold 124. The materials are kept under controlled temperature conditions to insure that the desired reaction profile is maintained.

The polyol component typically contains additives, such as stabilizers, flow modifiers, catalysts, combustion modifiers, blowing agents, fillers, pigments, optical brighteners, and release agents to modify physical characteristics of the cover. Recycled polyurethane/polyurea also can be added to the core. Polyurethane/polyurea constituent molecules that were derived from recycled polyurethane can be added in the polyol component. Inside the mix head 116, injector nozzles impinge the isocyanate and polyol at ultra-high velocity to provide excellent mixing. Additional mixing preferably is conducted using an aftermixer 130, which typically is constructed inside the mold between the mix head and the mold cavity.

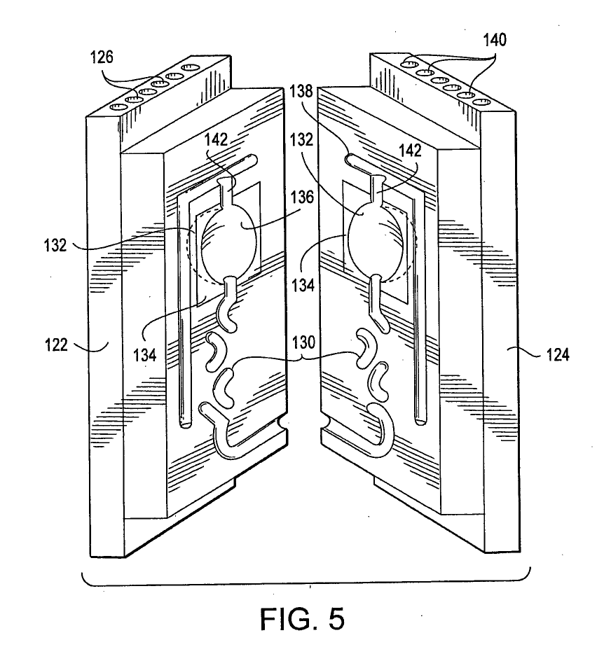

As is shown in FIG. 5, the mold includes a golf ball cavity chamber 132 in which a spherical golf ball cavity 134 with a dimpled, inner spherical surface 136 is defined. The aftermixer 130 can be a peanut aftermixer, as is shown in FIG. 5, or in some cases another suitable type, such as a heart, harp or dipper. However, the aftermixer does not have to be incorporated into the mold design. An overflow channel or dump well 138 receives overflow material from the golf ball cavity 134 through a shallow vent 142. Heating/cooling passages 126 and 140, which preferably are in a parallel flow arrangement, carry heat transfer fluids such as water, oil, etc. through the top mold 122 and the bottom mold 124.

Preferably, a plurality of deep dimple projections are defined within the chamber 132, and specifically, which extend from the molding surface. The deep dimple projections serve to support and center a golf ball core or intermediate golf ball assembly within the chamber 132. The mold cavity can optionally utilize retractable pins and is generally constructed in the same manner as a mold cavity used to injection mold a thermoplastic, e.g., ionomeric golf ball cover. However, if such pins are utilized, two differences when RIM is used are that tighter pin tolerances generally are required, and a lower injection pressure is used. Also, the molds can be produced from lower strength material such as aluminum.

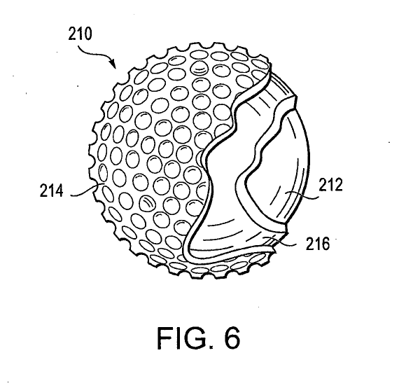

Referring to FIG. 6, another preferred embodiment golf ball 210 in accordance with the exemplary embodiment is illustrated. The golf ball 210 includes a central core 212 which may be solid or liquid as known in the art. A cover 214 is surroundingly disposed about the central core 212. An intermediate layer 216 may be present between the central core 212 and the cover 214. The exemplary embodiment primarily relates to the cover 214 and will be described with particular reference thereto, but it is also contemplated to apply to molding of the intermediate layer 216.

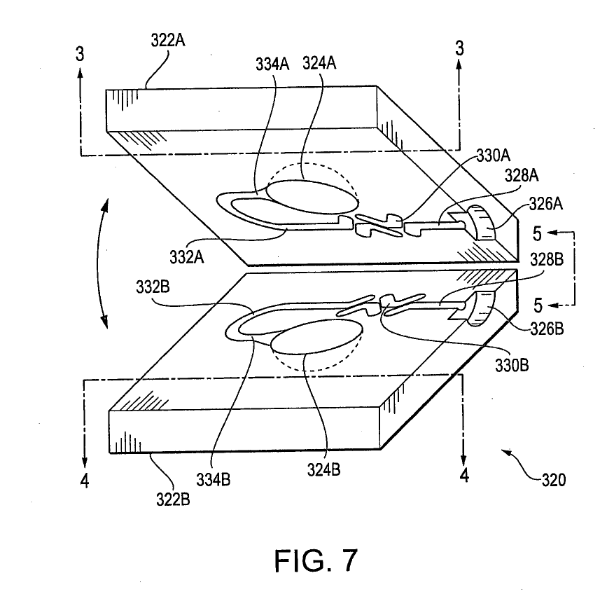

Turning now to FIG. 7, a perspective view of a preferred embodiment molding assembly in accordance with the current exemplary embodiment is shown. As previously noted, complete and timely mixing of two or more constituent materials is important when using a reaction injection molding (‘RIM’) process. The preferred embodiment molding assembly 320 provides such mixing as a result of its unique design and configuration. An injection machine, as known in the art, is connected to the preferred embodiment molding assembly 320 which comprises an upper half 322A and a lower half 322B. As will be appreciated, the upper and lower halves 322A and 322B are preferably formed from a metal or suitable alloy. A mixing chamber may, as known in the art, precedes the molding assembly 320 if desired. In a further aspect of the exemplary embodiment, the molding assembly 320 is utilized as follows. A core 212 (referring to FIG. 6) is positioned within a central cavity formed from two hemispherical depressions 324A and 324B defined in opposing faces of the upper half and lower half 322A and 322B, respectively, of the molding assembly 320. As will be appreciated, when the upper and lower halves 322A and 322B are closed, and the cavities 324A and 324B are aligned with each other, the resulting cavity has a spherical configuration. If the molding assembly is for molding a cover layer, each of the hemispherical cavities 324A and 324B will define a plurality of raised regions that, upon molding a cover layer therein, will result in corresponding dimples on the cover layer. Preferably, a plurality of deep dimple projections are defined within the molding cavity, and specifically, which project from the molding surface. The deep dimple projections serve to support and center a golf ball core or intermediate golf ball assembly within the molding cavity.

Each upper and lower half 322A and 322B of the preferred embodiment molding assembly 320 defines an adapter portion 326A and 326B to enable the body 320 to connect to other process equipment as mentioned above and leads to a material inlet channel 328A and 328B as illustrated in FIG. 7. As will be understood, upon closing the upper and lower halves 322A and 322B of the molding assembly 320, the separate halves of adapter portion 326A and 326B are aligned with each other and create a material flow inlet within the molding assembly. And, each upper and lower half 322A and 322B of the assembly 320 further defines flow channels 328A and 328B, 330A and 330B and 332A and 332B which create a comprehensive flow channel within the molding assembly when the upper and lower halves 322A and 322B are closed. Specifically, the material flow inlet channel portion 328A, 328B receives the constituent materials from the adapter portion 326A and 326B and directs those materials to a turbulence-promoting portion of the channel 330A, 330B which is configured to form at least one peanut or after-mixer. The upper and lower mold halves 322A and 322B include complimentary turbulence-promoting fan gate channel portions 330A and 330B, respectively. It will be appreciated that upon closing the upper and lower halves 322A and 322B of the molding assembly 320, the channel portion 330A and 330B defines a region of the flow channel that is generally nonlinear and includes a plurality of bends and at least one branching intersection generally referred to herein as an after-mixer. Each after-mixer channel portion 330A, 330B is designed to direct material flow along an angular or tortuous path. As will be described in more detail below, when material reaches a terminus of angular flow in one plane of the flow channel in one half, the material flows in a transverse manner to a corresponding fan gate channel portion in the opposing half. Thus, when the constituent materials arrive at the after-mixer defined by the channel portion 330A and 330B, turbulent flow is promoted, forcing the materials to continue to mix within the molding assembly 320. This mixing within the molding assembly 320 provides for improved overall mixing of the constituent materials, thereby resulting in a more uniform and homogeneous composition for the cover 214.

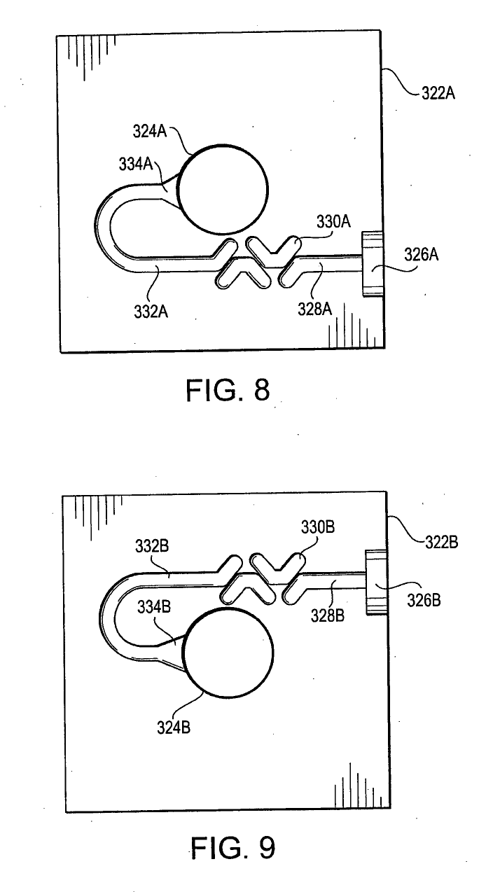

With continuing reference to FIGS. 8 and 9, views 3-3 and 4-4 from FIG. 7, respectively, are provided. These views illustrate additional details of the exemplary embodiment as embodied in the mold upper and lower halves 322A and 322B. The material inlet channel 328A and 328B allows entry of the constituents which are subsequently directed through the turbulence-promoting channel portion 330A and 330B, which forms the after-mixer, then through the connecting channel portion 332A and 332B and to a fan gate portion 334A and 334B which leads into the molding cavity 324A and 324B. The fan gate portion 334A and 334B may be defined in various forms extending to the cavity 324A and 324B.

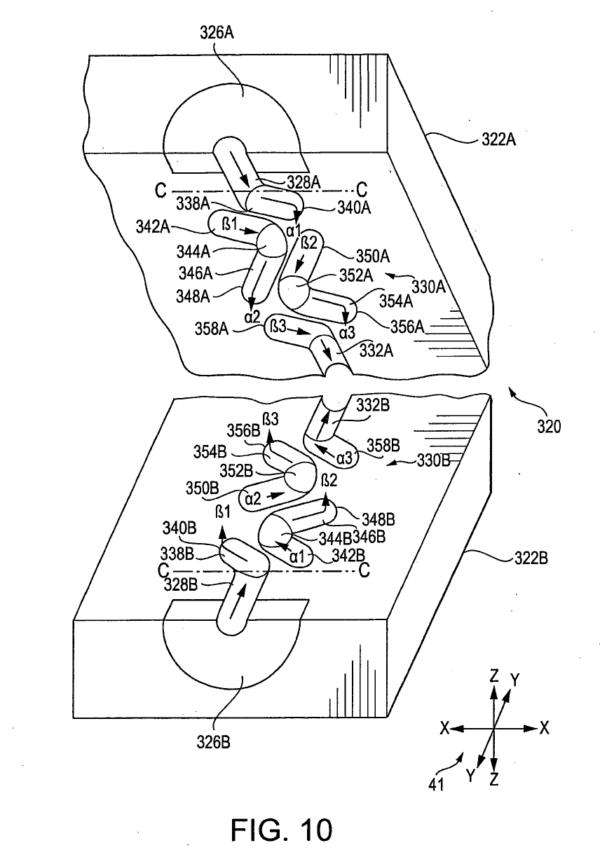

Turning now to FIG. 10, a perspective view of the mold body 320 illustrates the details of material flow and mixing provided by the current exemplary embodiment. The body halves 322A and 322B are shown in an open position, i.e., removed from one another, for purposes of illustration only. It will be appreciated that the material flow described below takes place when the halves 322A and 322B are closed. The adapter portion 326A, 326B leads to the inlet flow channel 328A, 328B which typically has a uniform circular cross section of 360E. The flowing material proceeds along the inlet channel 328A, 328B until it arrives in a location approximately at a plane designated by line C-C. At this region, the material is forced to split apart by a branching intersection 338A and 338B. Each half of the branching intersection 338A and 338B is divergent, extending in a direction generally opposing the other half. For example, portion 338A extends upward and 338B extends downward relative to the inlet channel 328A, 328B as shown. Each half of the branching intersection 338A and 338B, in the illustrated embodiment, is semicircular, or about 180E in curvature. The separated material flows along each half of the branching intersection 338A and 338B until it reaches a respective planar wall, 340A and 340B.

At each first planar wall 340A and 340B, the material can no longer continue to flow within the plane of the closed mold, i.e., the halves 322A and 322B being aligned with one another. To aid the present description it will be understood that in closing the mold, the upper half 322A is oriented downward (referring to FIG. 10) so that it is generally parallel with the lower half 322B. The orientation of the halves 322A and 322B in such a closed configuration is referred to herein as lying in an x-y plane. As explained in greater detail herein, the configuration of the exemplary embodiment after-mixer provides one or more flow regions that are transversely oriented to the x-y plane of the closed mold. Hence, these transverse regions are referred to as extending in a z direction.

Specifically, at the first planar wall 340A the material flows from a point α1 in one half 322A to a corresponding point α1 in the other half 322B. Point α1 in half 322B lies at the commencement of a first convergent portion 342B. Likewise, at the first planar wall 340B the material flows from a point β1 in one half 322B to a corresponding point β1 in the other half 322A. The point β1 in half 322A lies at the commencement of a first convergent portion 342A. The first convergent portion 342A and 342B brings the material to a first common area 344A and 344B. In the shown embodiment, each first convergent portion is parallel to each first diverging branching intersection to promote a smooth material transfer. For example, the portion 342A is parallel to the portion 338A, and the portion 342B is parallel to the portion 338B.

With continuing reference to FIG. 10, the flowing material arrives at the first common area 344A and 344B, which has a full circular, i.e., 360E, cross section when the halves 322A and 322B are closed. Essentially, the previously separated material is rejoined in the first common area 344A and 344B. A second branching intersection 346A and 346B which is divergent then forces the material to split apart a second time and flow to each respective second planar wall 348A and 348B. As with the first planar wall 340A and 340B, the material, upon reaching the second planar wall 348A and 348B can no longer flow in an x-y plane and must instead move in a transverse z-direction. For example, at the planar wall 348A, the material flows from a point α2 in one half 322A to a corresponding point α2 in the other half 322B, which lies in a second convergent portion 350B. The material reaching the planar wall 348B flows from a point β2 in one half 322B to a corresponding point β2 in the other half 322A, which lies in a second convergent portion 350A.

In the shown embodiment, each second convergent portion 350A and 350B, is parallel to each second diverging branching intersection 346A and 346B. For example, the portion 350A is parallel to the portion 346A and the portion 350B is parallel to the portion 346B. The second convergent portion 350A and 350B forces the material into a second common area 352A and 352B to once again rejoin the separated material. As with the first common area 344A and 344B, the second common area 352A and 352B has a full circular cross section. After the common area 352A and 352B, a third branching intersection 354A and 354B again diverges, separating the material and conveying it in different directions. Upon reaching each respective third planar wall, i.e., the planar wall 356A in the portion 354A and the planar wall 356B in the portion 354B, the material is forced to again flow in a transverse, z-direction from the planar x-y direction. From a point α3 at the third planar wall 356A in one half 322A, the material flows to a corresponding point α3 in the other half 322B, which lies in a third convergent portion 358B. Correspondingly, from a point β3 at third planar wall 356B in one half 322B, the material flows to a corresponding point β33 in the other half 322A, which is in a third convergent portion 358A.

The turbulence-promoting after-mixer structure 330A and 330B ends with a third convergent portion 358A and 358B returning the separated material to the connecting flow channel 332A and 332B. The connecting channel 332A and 332B is a common, uniform circular channel having a curvature of 360<. Once the material enters the connecting channel portion 332A and 332B, typical straight or curved smooth linear flow recommences.

By separating and recombining materials repeatedly as they flow, the exemplary embodiment provides for increased mixing of constituent materials. Through the incorporation of split channels and transverse flow, mixing is encouraged and controlled while the flow remains uniform, reducing back flow or hanging-up of material, thereby reducing the degradation often involved in non-linear flow. Particular note is made of the angles of divergence and convergence of the after-mixer portions 338A and 338B, 342A and 342B, 346A and 346B, 350A and 350B, 354A and 354B and 358A and 358B, as each extends at the angle of about 30E to 60E from the centerline of the linear inlet flow channel 328A, 328B. This range of angles allows for rapid separation and re-convergence while minimizing back flow. In addition, each divergent branching portion and converging portion 338A and 338B, 342A and 342B, 346A and 346B, 350A and 350B, 354A and 354B and 358A and 358B extends from the centerline of the linear inlet flow channel 328A, 328B for a distance of one to three times the diameter of the channel 328A, 328B before reaching its respective planar wall 340A and 340B, 348A and 348B and 356A and 356B. Further note is made of the common areas 344A and 344B and 352A and 352B. These areas are directly centered about a same linear centerline which extends from the inlet flow channel portion 328A, 328B to the commencement of the connecting flow channel portion 332A, 332B. As a result, the common areas 344A and 344B and 352A and 352B are aligned linearly with the channel portions 328A, 328B and 332A, 332B, providing for more consistent, uniform flow. While several divergent, convergent, and common portions are illustrated, it is anticipated that as few as one divergent and convergent portion or as many as ten to twenty divergent and convergent portions may be used, depending upon the application and materials involved.

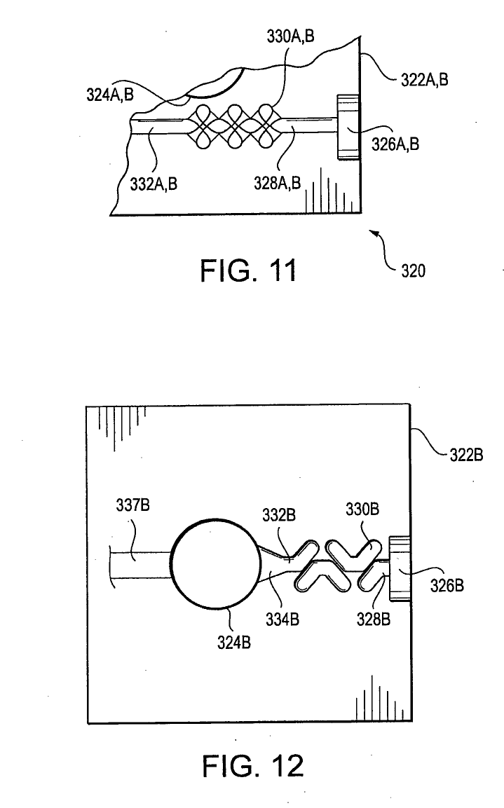

FIG. 11 schematically depicts the turbulence-promoting after-mixer channels 330A, 330B when the molding assembly 320 is closed. As described above, upon closure, the upper half 322A and the lower half 322B meet, thereby creating the turbulence-promoting after-mixer along the region of the channel portions 330A and 330B. The resulting after-mixer causes the constituent materials flowing therethrough to deviate from a straight, generally linear path to a nonlinear turbulence-promoting path. The interaction and alignment of the divergent branching intersections 338A and 338B, 346A and 346B, 354A and 354B (referencing back to FIG. 10), the convergent portions 342A and 342B, 350A and 350B, 58A and 358B, and the common portions 344A and 44B, and 352A and 52B, also as described above, is shown in detail. It is preferred that the after-mixer channel portion 330A, 330B be at least one tenth or 10% of the total flow channel length in the molding assembly 320 in order to provide sufficient turbulent flow length for adequate mixing for most constituent materials. That is, it is preferred that the total length of the after-mixer, measured along the path of flow along which a liquid traveling through the after-mixer flows, is at least one tenth of the total flow length as measured from the commencement of the inlet channel 328A, 328B through the after-mixer and through the connecting channel portion 332A, 332B to the end of the final portion 334A and 334B at the mold cavity 324A, 324B. For many applications, it may be preferred that the after-mixer length be about 15% to about 35%, and most preferably from about 20% to about 30%, of the total flow path length.

In a particularly preferred embodiment, the after-mixer includes a plurality of bends or arcuate portions that cause liquid flowing through the after-mixer to not only be directed in the same plane in which the flow channel lies, but also in a second plane that is perpendicular to the first plane. It is most preferable to utilize an after-mixer with bends such that liquid flowing therethrough travels in a plane that is perpendicular to both the previously noted first and second planes. This configuration results in relatively thorough and efficient mixing due to the rapid and changing course of direction of liquid flowing therethrough.

The configuration of the mold channels may take various forms. One such variation is shown in FIG. 12. Reference is made to the lower mold half 322B for the purpose of illustration, and it is to be understood that the upper mold half 322A (not shown) comprises a complimentary configuration. The adapter portion 326B leads to the inlet flow channel 328B which leads to the turbulence-promoting channel portion 330B. However, instead of the adapter 326B and the channels 328B and 330B being spaced apart from the central cavity 324B, they are positioned approximately in line with the central cavity 324B, eliminating the need for the connecting channel portion 332B to be of a long, curved configuration to reach the final channel portion 334B. Thus, the connecting channel 332B is a short, straight channel, promoting a material flow path which may be more desirable for some applications. The flow channels and the central cavity may be arranged according to other forms similar to those shown, which may occur to one skilled in the art, as equipment configurations and particular materials and applications dictate.

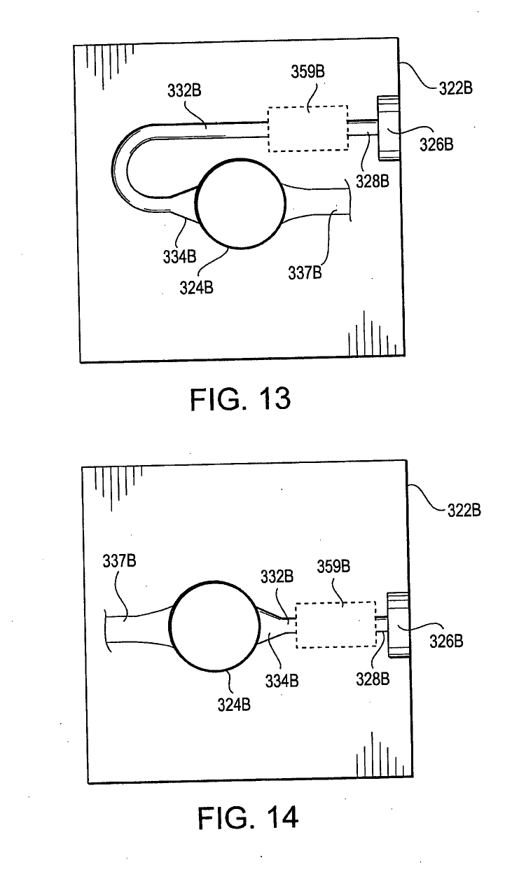

In the above-referenced figures, the channels 330A and 330B are depicted as each comprising a plurality of angled bends or turns. Turning now to FIG. 13, the channels are not limited to the angled bend-type after-mixer configuration and include any turbulence-promoting design located in a region 359B between the adapter portion 326B and the cavity 324B. Again, reference is made to the lower mold half 322B for the purpose of illustration, and it is to be understood that the upper mold half 322A (not shown) is complimentary to the lower mold half 322B. The channels in the turbulence-promoting region 359A (not shown) and 359B could be formed to provide one or more arcuate regions such that upon closure of the upper and lower mold halves 322A and 322B, the after-mixer has, for example, a spiral or helix configuration. Regardless of the specific configuration of the channels in the turbulence promoting portion 359A and 359B, the shape of the resulting after-mixer insures that the materials flow through the turbulence-promoting region and thoroughly mix with each other, thereby reducing typical straight laminar flow and minimizing any settling in a low-flow area where degradation may occur. And, as previously noted, such thorough mixing of the materials has been found to lead to greater consistency and uniformity in the final physical properties and characteristics of the resulting golf ball layer or component.

As shown in FIG. 14, the turbulence-promoting region 359A (not shown) and 359B may be placed in various locations in the upper and lower mold halves 322A (not shown) and 322B. As mentioned above, the turbulence-promoting region 359B and the other flow channel portions 328B, 332B, and 334B may be arranged so as to create an approximately straight layout between the adapter portion 326B and the central molding cavity 324B. By allowing flexibility in the location of the turbulence-promoting region 359B and the other channel portions 328B, 332B and 334B, as well as the adapter 326B and the central cavity 324B, optimum use may be made of the exemplary embodiment in different applications.

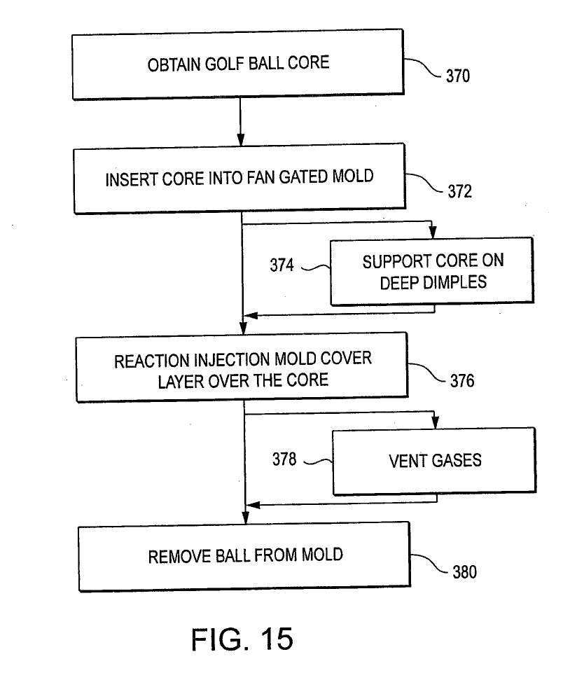

A preferred method of making a golf ball in accordance with the exemplary embodiment is illustrated in FIG. 15. A golf ball core 212 (FIG. 6) made by techniques known in the art is obtained, illustrated as step 370. It will be appreciated that instead of the core 212, an intermediate golf ball assembly, such as the core 212 and a mantle layer 216, can be utilized. The core 212 is preferably positioned within a mold having venting provisions and fan gates as described herein. This is illustrated as step 372. The core 212 is supported on a plurality of deep dimples. This is shown as step 374. The cover layer 214 is molded over the core 212 by reaction injection molding (‘RIM’) as step 376. If venting of gases from the molding cavity is desired, such gases are preferably vented as previously described. This is designated as step 378. Should increased removal of gases be desired, the venting of step 378 is enhanced by providing a vacuum connection as known in the art to the venting channel. When the molding is complete, the golf ball 210 is removed from the mold, as shown by step 380. Part removal can be accomplished by mold shifting. Venting is preferably accomplished by the vent features described herein.

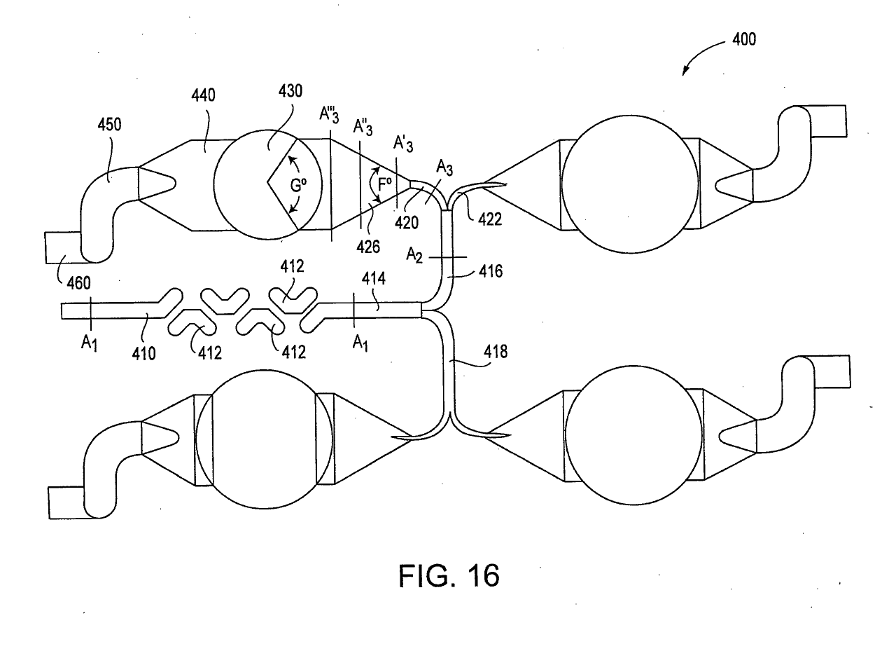

In certain versions of the exemplary embodiment, and particularly for RIM operations, it can be beneficial to utilize a runner and gate configuration that has approximately constant flow cross-sectional area from nozzle to mold. In many of the runners, gates, and vents described herein, reference is made to the cross-sectional area of the particular feature. The cross section is taken in a direction that is generally perpendicular to the flow of molding material, thus the term “flow cross-sectional area.” Specifically, referring to FIG. 16, a schematic view of a multi-array golf ball mold assembly 400 is illustrated. Reference will be made to one of the molds in that assembly, however it will be appreciated that the other molds feature a similar or identical configuration. An inlet channel 410 is defined within the mold 400. The cross-sectional area of the inlet channel 410 is designated as A₁. Downstream of the channel 410 is a turbulence-inducing mixing region including a plurality of bends 412, as previously described herein. Downstream of the mixing region is a primary flow channel or runner 414 that provides feed for the plurality of golf ball molding cavities. The exemplary embodiment utilizes a unique branching relationship for primary, secondary and tertiary runners that receive flowable molding material from the primary runner 414. Referring to FIG. 16, when a primary runner with cross-sectional area A₁ forks or splits, the area of the secondary runner A₂ should be approximately half that of A₁. Specifically, the primary runner 414 splits into two secondary runners 416 and 418. The cross-sectional area A₁ of primary runner 414 equals the sum of the cross-sectional area A₂ of the secondary runner 416 and that of the secondary runner 418.

Furthermore, when the secondary runner of cross sectional area A₂ forks or splits, the area of the tertiary runner A₃ should be approximately half that of A₂ or a quarter of A₁. Referring to FIG. 16, thus, the cross-sectional area A₂ of the secondary runner 416 equals the sum of the cross-sectional area A₃ of the tertiary runner 420 and that of the tertiary runner 422.

When a tertiary or other runner widens into the gate where the molding material enters the molding cavity, the cross-sectional area should be maintained constant at A₃. Thus, referring to FIG. 16, the tertiary runner 420 provides communication to a fan gate 426. The fan gate has a diverging or widening opening as molding material flows into it from the tertiary runner 420 to a molding cavity 430. The length of the fan gate from the exit of the runner to the inlet of the molding cavity is referred to herein as the fan gate “flow length.” The fan gate widens according to an angle F, described in greater detail herein. The cross-sectional area however, within the fan gate 426 remains constant, or at least substantially so, and is preferably equal to the cross-sectional area of the tertiary runner 420, A₃. Specifically, the cross-sectional areas A₃′, A₃″, and A₃′″, within the fan gate 426 are all the same, and each is equal, or at least approximately the same as the cross-sectional area A₃ of the tertiary runner 420. As noted, the angle through which the tertiary runner widens is referred to herein as the fan gate angle F. This angle should be within the range of from about 20° to about 175°, preferably from about 30° to about 150°, and most particularly from about 40° to about 70°. From the inlet's perspective, the lateral edges of the inlet widen at an angle referred to herein as the fan gate angle or the material flow front included angle.

The fan gate can be extended such that its edges are tangent to the molding cavity 430 or the fan gate can be held at a maximum width. The maximum width is crucial for determining how the material flow front enters the molding cavity 430 and flows over the mantle or core disposed therein. The goal is to avoid entrapping air pockets in the material which can otherwise occur by allowing the flow front to be non-uniform or irregular. An important metric for characterizing flow into a spherical cavity with a spherical insert is the projected gate angle, which is designated in FIG. 16 as angle G. This angle should be in the range of from about 5° to about 180°, particularly from about 45° to about 165° and most particularly from about 120° to about 150°. As can be seen with reference to FIG. 16, as the width of the fan gate 426 approaches the diameter of the molding cavity 430, the angle G approaches 180°. As the width of the fan gate 426 narrows, the angle G, defined by the intersection of the fan gate and the molding cavity, decreases. The fan gate angle, i.e. angle F, intersects the golf ball cavity at a specific gate width. When line segments are drawn from the spherical center of the cavity to each edge of the gate's width, a different angle can potentially be defined. This angle is the projected gate angle.

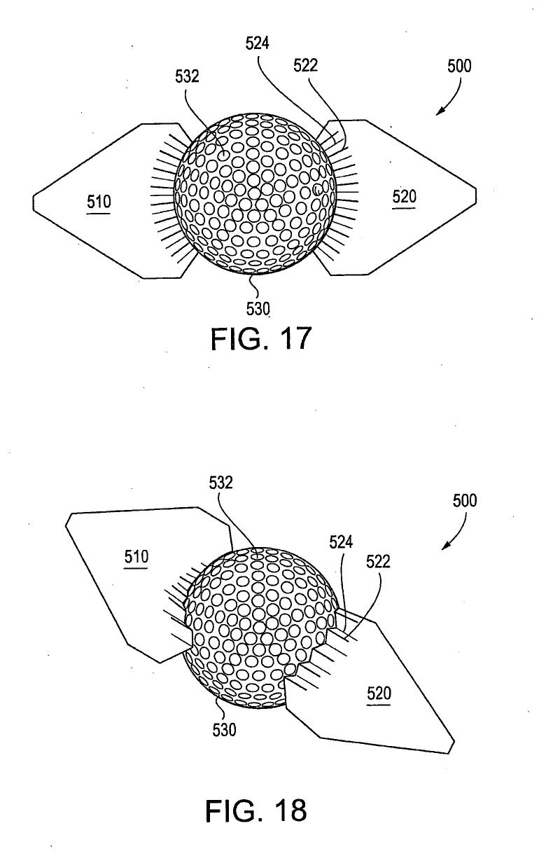

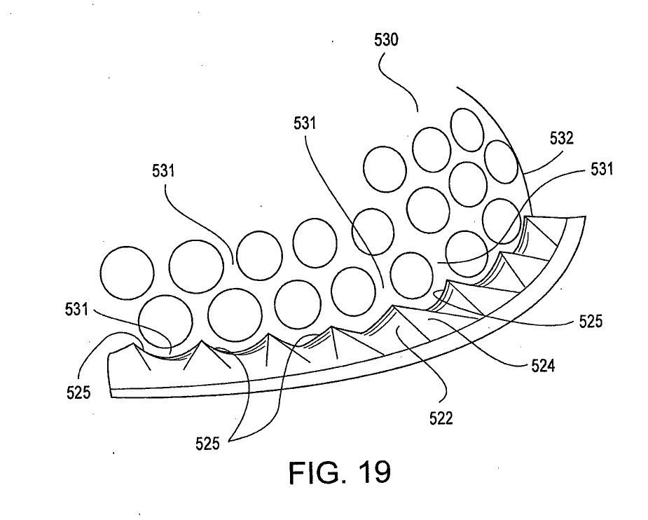

The exemplary embodiment also provides a vent design with a similar fan angle and material flow front included angle. A vent region is generally provided on the downstream side of the molding cavity. A key difference between this vent and the fan gate, located upstream of the molding cavity, is that the vent area is not held constant. The vent thickness is held constant but the vent width changes, i.e. decreases with the taper of the vent angle. Progressing downstream through the vent, the vent generally converges. This allows the material flow resistance to increase and build back pressure in the rapidly gelling RIM material in the molding cavity. This increased pressure pushes entrapped gases into solution or form bubbles small enough to not produce a cosmetic defect. Thus, in accordance with the exemplary embodiment, the vent has a converging geometry or shape while the thickness of the vent remains constant across at least a majority of the vent flow length. A vent 440 is shown in FIG. 16 with such characteristics. The vent 440 terminates with a volume that is referred to herein as the dump well. The dump well is shown as 450 and must be vented to the atmosphere so that the pressure within the mold, cavity and runner(s) does not increase due to the accumulation of gas or air displaced by the air injected RIM material. Such venting can be achieved by an outlet 460. In addition to the runner and fan gate design, the mold assembly 40° can incorporate a non-planar parting line, as shown in FIGS. 17-22. The non-planar parting line prevents cosmetic defects at the ball's seam by breaking up polymer chains. The non-planar parting line hides the seam to improve aesthetics and improve aerodynamic performance and symmetry of flight. Specifically, in assembly 500, a golf ball 530 having dimples 532 is formed by positioning a core or ball assembly in a molding cavity and generally positioned between an inlet fan gate 510 and a vent outlet 520. The fan gate and the vent are as previously described with regard to FIG. 16. Where the fan and vent meet the ball cavity, the gate geometry includes a plurality of peaks and valleys 522, 524 that extend across the equator of the ball in a zipper-like or zigzag fashion. This is particularly shown in FIG. 19. The peaks and valleys, in certain embodiments, can be arcuate and have a radius to assist in the reduction of drag on the material flow. Preferably, the parting line, designated in FIG. 19 as mold edge 525, does not extend over or across any dimple 532. Instead, the parting line, i.e. corresponding to the mold interface edge 525, extends along land areas 531 on the surface of the ball 530, between dimples 532.

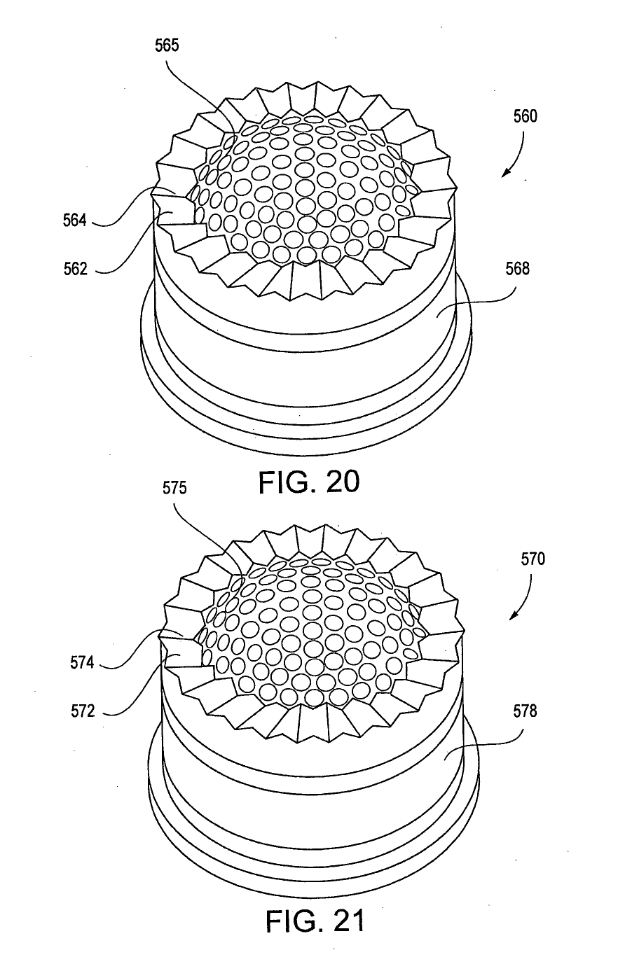

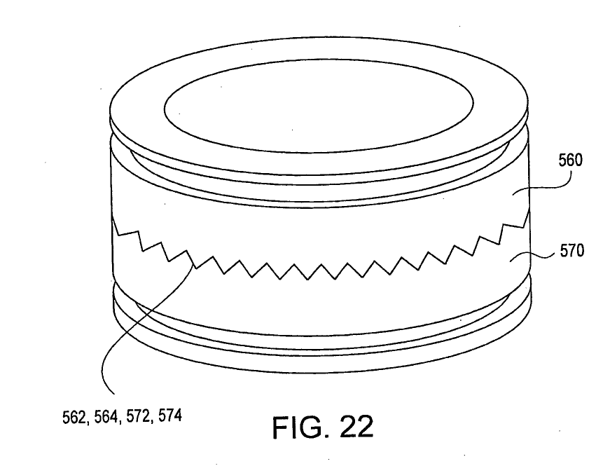

FIGS. 20-22 depict a further embodiment of a molding assembly comprising molds that utilize a non-planar parting line. Specifically, FIG. 20 illustrates a top or first mold 560 defining a molding surface 565 formed within a molding member 568. The molding surface 565 can optionally define a plurality of raised projections that define dimples in a cover layer of a golf ball molded therein. Extending around the opening of the molding surface 565 is an interface region including a collection of raised projections 562 and depressions 564. These alternating depressions and projections along an interface edge region of the mold define a non-planar parting line. Similarly, FIG. 21 illustrates a bottom or second mold 570 defining a molding surface 575 formed within a molding member 578. Extending around the opening of the molding surface 575 is an interface region including a collection of projections 572 and depressions 574. FIG. 22 illustrates engagement of the molds 560 and 570.

The golf balls formed according to the exemplary embodiment can be coated using a conventional two-component spray coating or can be coated during the RIM process, i.e., using an in-mold coating process.

One of the significant advantages of the RIM process according to the exemplary embodiment is that polyurethane or other cover materials can be recycled and used in golf ball cores. Recycling can be conducted by, e.g., glycolysis. Typically, 10 to 90% of the material which is injection molded actually becomes part of the cover. The remaining 10 to 90% is recycled.

Recycling of polyurethanes by glycolysis is known from, for example, RIM Part and Mold Design—Polyurethanes, 1995, Bayer Corp., Pittsburgh, Pa. Another significant advantage of the exemplary embodiment is that because reaction injection molding occurs at low temperatures and pressures, i.e., 90 to 180° F. and 50 to 200 psi, this process is particularly beneficial when a cover is to be molded over a very soft core. When higher pressures are used for molding over soft cores, the cores “shut off” i.e., deform and impede the flow of material causing uneven distribution of cover material.

One polyurethane component which can be used in the exemplary embodiment incorporates TMXDI (META) aliphatic isocyanate (Cytec Industries, West Paterson, N.J.). Polyurethanes based on meta-tetramethylxylyliene diisocyanate can provide improved gloss retention, UV light stability, thermal stability and hydrolytic stability. Additionally, TMXDI (META) aliphatic isocyanate has demonstrated favorable toxicological properties. Furthermore, because it has a low viscosity, it is usable with a wider range of diols (to polyurethane) and diamines (to polyureas). If TMXDI is used, it typically, but not necessarily, is added as a direct replacement for some or all of the other aliphatic isocyanates in accordance with the suggestions of the supplier. Because of slow reactivity of TMXDI, it may be useful or necessary to use catalysts to have practical demolding times. Hardness, tensile strength and elongation can be adjusted by adding further materials in accordance with the supplier's instructions.

Golf ball cores also can be made using the materials and processes of the exemplary embodiment. To make a golf ball core using RIM polyurethane, the same processing conditions are used as are described above with respect to covers. One difference is, of course, that no retractor pins are needed in the mold. Furthermore, an undimpled, smaller mold is used. If, however, a one piece ball is desired, a dimpled mold would be used. Polyurethanes also can be used for cores.

Golf balls typically have indicia and/or logos stamped or formed thereon. Such indicia can be applied by printing using a material or a source of energetic particles after the ball core

Non-limiting examples of polyurethanes/polyureas suitable for use in the layer(s) include the following.

Several systems available from Bayer include Bayflex 110-50 and Bayflex MP-10,000.

BAYFLEX ® Polyurethane Elastomeric RIM

| | | | 110-50 | | | | |
|---|---|---|---|---|---|---|---|
| | ASTM Test | U.S. Conven- | | 15% | 15% | 110-50 CM | MP-10,000 |
| Typical Properties | Method (Other) | tional Units | Unfilled | Glass¹ | Mineral² | Unfilled | Unfilled |
| GENERAL | | | | | | | |
| Specific Gravity | D 792 | | 1.04 | 1.14 | 1.15 | 1.04 | 1.1 |
| Density | D 1622 | lb/ft³ | 64.9 | 71.2 | 71.8 | 64.9 | 68.7 |
| Thickness | | in | 0.125 | 0.125 | 0.125 | 0.125 | 0.118 |
| Shore Hardness | D 2240 | A or D | 58 D | 60 D | 60 D | 51 D | 90 A |
| Mold Shrinkage | (Bayer) | % | 1.3 | 0.7 | 0.6 | 1.3 | 1.42 |
| Water Immersion, Length Increase | (Bayer) | in/in | 0.006 | 0.002 | | | 0.014 |
| Water Absorption: | (Bayer) | | | | | | |
| 24 Hours | | % | | | | | 3.3 |
| 240 Hours | | % | 2.8 | 2.6 | | | 5.0 |
| MECHANICAL | | | | | | | |
| Tensile Strength, Ultimate | D 638/D 412 | lb/in² | 3,500 | 2,800 | 3,300 | 3,300 | 2,200 |
| Elongation at Break | D 638/D 412 | % | 250 | 200 | 140 | 360 | 300 |
| Flexural Modulus: | D 790 | | | | | | |
| 149° F. | | lb/in² | 38,000 | 60,000 | 111,000 | 27,000 | 7,900 |
| 73° F. | | lb/in² | 52,000 | 100,000 | 125,000 | 46,000 | 10,000 |
| −22° F. | | lb/in² | 115,000 | 160,000 | 250,000 | 97,000 | 23,600 |
| Tear Strength, Die C | D-624 | lbf/in | 450 | 620 | 640 | 500 | 240 |
| Impact Strength: | D 256 | | 450 | 620 | 640 | 500 | 240 |
| Notched Izod | | ft lb/in | 11 | 8 | 3 | 9 | |
| THERMAL | | | | | | | |
| Heat Sag: | D 3769 | | | | | | |
| 6-in Overhang, 1 hr at 375° F. | | in | | | | | |
| 6-in Overhang, 1 hr at 250° F. | | in | 0.60 | 028 | | | |
| 4-in Ovrhang, 1 hr at 250° F. | | in | 0.36 | 0.27 | 0.16 | 0.6 | |
| Coefficient of Linear Thermal | D 696 | in/in° F. | 61E−06 | 44E−06 | 27E−06 | 85E−06 | 53E−06 |
| Expansion | | | | | | | |
| FLAMMABILITY | | | | | | | |
| UL94 Flame Class: | (UL94) | | | | | | |
| 0.125-in (3.18-mm) Thickness | | Rating | HB | | | V-2 | |

¹Milled glass fiber, OCF 737, 1/16 inch.
²RRIMGLOS 10013 (RRIMGLOS is a trademark of NYCO Minerals, Inc.).
Note 1
All directional properties are listed parallel to flow.

BAYFLEX MP-10,000 is a two component system, consisting of Component A and Component B. Component A comprises the diisocyanate and Component B comprises the polyether polyol plus additional curatives, extenders, etc. The following information is provided by the BAYFLEX MP-10,000 MSDS sheet, regarding the constituent components.

Component A

| 1. | Chemical Product Information (Section 1) | |
|---|---|---|
| | Product Name: | BAYFLEX MP-10,000 |
| | | Component A |
| | Chemical Family: | Aromatic Isocyanate Prepolymer |
| | Chemical Name: | Diphenylmethane Diisocyanate |
| | | (MDI) Prepolymer |
| | Synonyms: | Modified Diphenylmethane |
| | | Diisocyanate |
| 2. | Composition/Information on Ingredients (Section 2) | |
| | Ingredient | Concentration |
| | 4,4′-Diphenylmethane | 53-54% |
| | Diisocyanate (MDI) | |
| | Diphenylmethane Diisocyanate | 1-10% |
| | (MDI) (2,2; 2,4) | |
| 3. | Physical and Chemical Properties (Section 9) | |
| | Molecular Weight: | Average 600-700 |
| 4. | Regulatory Information (Section 15) | |
| | Component | Concentration |
| | 4,4′-Diphenylmethane | 53-54% |
| | Diisocyanate (MDI) | |
| | Diphenylmethane Diisocyanate | 1-10% |
| | (MDI) (2,2; 2,4) | |
| | Polyurethane Prepolymer | 40-50% |

Component B

| 1. | Chemical Product Information (Section 1) | |
|---|---|---|
| | Product Name: | BAYFLEX MP-10,000 |
| | | Component B |
| | Chemical Family: | Polyether Polyol System |
| | Chemical Name: | Polyether Polyol containing |
| | | Diethyltoluenediamine |
| 2. | Composition/Information on Ingredients (Section 2) | |
| | Ingredient | Concentration |
| | Diethyltoluenediamine | 5-15% |
| 3. | Transportation Information (Section 14) | |
| | Technical Shipping Name: | Polyether Polyol System |
| | Freight Class Bulk: | Polypropylene Glycol |
| | Freight Class Package: | Polypropylene Glycol |
| 4. | Regulatory Information (Section 15) | |
| | Component Name | Concentration |
| | Diethyltoluenediamine | 5-15% |
| | Pigment dispersion | Less than 5% |
| | Polyether Polyol | 80-90% |

Additionally, Bayer reports the following further information:

Component A

| Isocyanate: | 4,4 diphenylmethane diisocyanate (MDI) |
|---|---|
| Functionality: | 2.0 |
| Curing Agents: | None |
| Diisocyanate | 60% free MDI; remaining 40% has reacted |
| Concentration: | |
| % NCO: | 22.6 (overall) |
| Equivalent Weight: | 186 |

Component B

| | |
|---|---|
| Polyol: | Trio containing derivatives of polypropylene |
| | glycol |
| Functionality: | 3.0 |
| Equivalent Weight: | 2,000 |
| Amine Extender: | Diethyltoluenediamine (equivalent weight of 88) |

According to Bayer, the following general properties are produced by this RIM system:

| | Typical Physical | | | ASTM Test |
|---|---|---|---|---|
| Property | Properties | Value | | Method |
| General | Specific Gravity | 1.1 | | D 792 |
| | Density | 68.7 | lb/ft³ | D 1622 |
| | Thickness | 0.118 | in | |
| | Shore Hardness | 90 A, 110 D | | D 2240 |
| | Mold Shrinkage | 1.42% | | (Bayer) |
| | Water Immersion, | 0.014 | in/in | (Bayer) |
| | Length Increase | | | |
| | Water Absorption: 24 Hours | 3.3% | | (Bayer) |
| | Water Absorption: 240 Hours | 5.0% | | (Bayer) |
| Mech- | Tensile Strength, Ultimate | 2,200 | lb/in² | D 638/D 412 |
| anical | Elongation at Break | 300% | | D 638/D 412 |
| | Flexural Modulus: 149° F. | 7,900 | lb/in² | D 790 |
| | Flexural Modulus: 73° F. | 10,000 | lb/in² | D 790 |
| | Flexural Modulus: −22° F. | 23,600 | lb/in² | D 790 |
| | Tear Strength, Die C | 240 | lbf/in | D 624 |
| Thermal | Coefficient of Linear | 53E−06 | in/in/° F. | D 696 |
| | Thermal Expansion | | | |

Another suitable system for forming a RIM cover or golf ball component is Spectrum™ available from Dow Plastics. Dow SPECTRIM RM 907 is an isocyanate, which when used in conjunction with a particular polyol available from Dow under the designation DRG 235.01, produces a preferred polyurethane.

| | | DRG 235.01 | Spectrim |
|---|---|---|---|
| | | Developmental | RM 907 |
| Typical Properties | | Polyol | Isocyanate |
| OH Number | mgKOH/g | 145-155 | — |
| Water content | % | <0.1 | — |
| NCO content | % | — | ca. 26 |
| Color | — | Off-white | Pale yellow |
| Viscosity at 25° C. | cPs | 900-1000 | ca.125 |
| Specific gravity at 25° C. | g/cm³ | ca 1.02 | 1.21 |
| Storage temperature | ° C. | 15-25 | 25-40 |
| Storage stability⁽¹⁾ | months | 6 | 3 |

| Metering Ratio | parts by weight |
|---|---|
| Recommended metering ratio Polyol/Isocyanate⁽²⁾ | 100/44.5 |

| Processing Conditions | | |
|---|---|---|
| Component temperatures | ° C. | ca. 40 |
| Mold temperature | ° C. | 55-65 |
| Demolding time⁽³⁾ | sec. | 60-90 |

| Example Formulation: | parts by wt. |
|---|---|
| DRG 235.01 Developmental Polyol | 101 |
| Additives⁽⁴⁾ | 10 |
| Mineral Filler⁽⁴⁾ | 120 |
| Metering ratio, Polyol blend/Spectrim* RM 907 Iso. | 100/21 |

Typical Physical Properties (e.g. Example formulation)

| | | | |
|---|---|---|---|
| Density | kg/m³ | | ca. 1650 |
| Wall thickness | Mm | | 2.5 |
| Filler content | % | | 45 |
| Shore A hardness | — | DIN 53505-87 | 83 |
| Tear strength | N/cm | ASTM D 1004-90 | 254 |
| Elongation | % | ISO 1798-83 | 268 |
| Elongation (heat aged)⁽⁵⁾ | % | ISO 1798-83 | 245 |
| Fogging | Mg | DIN 75201/B-92 | 0.35 |

⁽¹⁾Stored in the original sealed drums in a dry place at the recommended temperature.
⁽²⁾Indicated metering ratio is for the components cited, prior to addition of any required additives.
⁽³⁾Demolding time depends upon the maximum part thickness, the formulation in use, and the process conditions.
⁽⁴⁾Additives and mineral filler pre-blended into polyol component
⁽⁵⁾24 hours at 100 deg. C.

Another suitable polyurethane/polyurea RIM system suitable for use with the exemplary embodiment is the VibraRIM system:

VibraRIM 813A

(ISO Component)
Physical Properties

| ATTRIBUTE | SPECIFICATION |
|---|---|
| % NCIO | 16.38-16.78 |
| Viscosity | 400-800 cps at 50 C. with #2 spindle @ 20 rpm |
| Color | Hellige Comparator: Gardner 3 max W/CL-620C-40 |

VibraRIM 813B

(Polyol Component)
Physical Properties

| ATTRIBUTE | SPECIFICATION |
|---|---|
| Equivalent Weight | TBD - Theoretical 270.5 +/− 5 |
| Viscosity | 100-200 cps at 50 C. (#2 spindle 720 rpm) |
| Color | WHITE - 4.84% PLASTICOLORS DR-10368 |
| Moisture | 0.10% Maximum |
| Reactivity | COA for charge weight of catalyst |
| Mixing | COA for charge weight of surfactant |

VibraRIM 813A (Iso) and 813B (Polyol) are available from Crompton Chemical, now Chemtura of Middlebury, Conn.

A sample plaque formed from the VibraRIM 813A and 813B components exhibited the following representative properties:

Plaque material Shore D (peak)=39

Specific gravity 1.098 g/cc

Flexural mod. (ASTM D 790)=7920 psi.

300% mod. (ASTM D 412)=2650 psi.

Young's mod. at 23 C (DMA)=75.5 MPa

Shear mod. at 23C (DMA)=11.6 MPa

Other soft, relatively low modulus thermoset polyurethanes may also be utilized to produce the inner and/or outer cover layers. These include, but are not limited to non-ionomeric thermoset polyurethanes including but not limited to those disclosed in U.S. Pat. No. 5,334,673. Other non-limiting examples of suitable RIM systems for use in the exemplary embodiment are Bayflex7 elastomeric polyurethane RIM systems, Baydur7 GS solid polyurethane RIM systems, Prism7 solid polyurethane RIM systems, all from Bayer Corp. (Pittsburgh, Pa.), SPECTRIM reaction moldable polyurethane and polyurea systems from Dow Chemical USA (Midland, Mich.), including SPECTRIM MM 373-A (isocyanate) and 373-B (polyol), and Elastolit SR systems from BASF (Parsippany, N.J.).

A wide array of materials may be used for the cores and mantle layer(s) of the exemplary embodiment golf balls. For instance, the core and mantle or interior layer materials disclosed in U.S. Pat. Nos. 5,833,553, 5,830,087, 5,820,489, and 5,820,488, which are all hereby incorporated by reference, may be employed.

In accordance with conventional molding techniques, the preferred embodiment molding processes described herein may utilize one or more mold release agents to facilitate removal of the molded layer or component from the mold.

A golf ball manufactured according the preferred method described herein exhibits unique characteristics. Golf ball covers made through compression molding and traditional injection molding include balata, ionomer resins, polyesters resins and polyurethanes. The selection of polyurethanes which can be processed by these methods is limited. Polyurethanes are often a desirable material for golf ball covers because balls made with these covers are more resistant to scuffing and resistant to deformation than balls made with covers of other materials.

Some of the unique characteristics exhibited by a golf ball according to the exemplary embodiment include a thinner cover without the accompanying disadvantages otherwise associated with relatively thin covers such as weakened regions at which inconsistent compositional differences exist. A traditional golf ball cover typically has a thickness in the range of about 0.060 inch to 0.080 inch. A golf ball of the exemplary embodiment may utilize a cover having a thickness of about 0.010 inch 0.050 inch. This reduced cover thickness is often a desirable characteristic. It is contemplated that thinner layer thicknesses are possible using the exemplary embodiment.

Because of the reduced pressure involved in RIM as compared to traditional injection molding, a cover or any other layer of the exemplary embodiment golf ball is more dependably concentric and uniform with the core of the ball, thereby improving ball performance. That is, a more uniform and reproducible geometry is attainable by employing the exemplary embodiment.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

We claim as our invention:

1. A reaction injection molding assembly adapted for molding a golf ball, the assembly comprising:
an inlet;
a flow channel providing communication between the inlet and a diverging fan gate; and
a diverging fan gate in communication with a molding chamber and disposed upstream thereof, the fan gate defining a cross-sectional area and a flow length;
wherein the cross-sectional area of the fan gate is substantially constant across the flow length of the fan gate.

2. The reaction injection molding assembly of claim 1 wherein the fan gate diverges at a fan gate angle within the range of from about 20° to about 175°.

3. The reaction injection molding assembly of claim 2 wherein the fan gate angle is from about 30° to about 150°.

4. The reaction injection molding assembly of claim 3 wherein the fan gate angle is from about 40° to about 70°.

5. The reaction injection molding assembly of claim 1 wherein the fan gate intersects the molding chamber to thereby define a gate projected angle ranging from about 5° to about 180°.

6. The reaction injection molding assembly of claim 5 wherein the gate projected angle is in the range of from about 45° to about 165°.

7. The reaction injection molding assembly of claim 6 wherein the gate projected angle is in the range of from about 120° to about 150°.

8. The reaction injection molding assembly of claim 1 further comprising:
a vent downstream of the molding chamber, the vent having a converging geometry while the vent thickness is constant across at least a majority of the vent flow length.

9. The reaction injection molding assembly of claim 1 wherein the molding chamber has a surface, the surface having a plurality of projections extending outward.

10. A reaction injection molding assembly adapted for molding golf balls, the assembly comprising:
an inlet for receiving flowing molding material;
a first molding chamber sized to receive a first golf ball precursor product;
a second molding chamber sized to receive a second golf ball precursor product; and
a plurality of flow channels providing flow communication between the inlet and both of the first molding chamber and the second molding chamber, the plurality of flow channels comprising a primary runner having a first cross-sectional area, and a plurality of secondary runners downstream of the primary runner, the plurality of secondary runners comprising a first secondary runner having a second cross-sectional area and a second secondary runner having a third cross-sectional area;
wherein the first cross-sectional area of the primary runner equals, or at least is substantially equal to, the sum of the second cross-sectional area of the first secondary runner and the third cross-sectional area of the second secondary runner.

11. The reaction injection molding assembly of claim 10, wherein the second cross-sectional area of the first secondary runner is equal or at least substantially so, to the third cross-sectional area of the second secondary runner.

12. The reaction injection molding assembly of claim 10 further comprising:
a third molding chamber sized to receive a golf ball precursor product;
wherein the plurality of flow channels also provide flow communication between the inlet and the third molding chamber, and the plurality of flow channels further comprises a plurality of tertiary runners downstream of at least one of the plurality of secondary runners, the plurality of tertiary runners comprising a first tertiary runner having a fourth cross-sectional area and a second tertiary runner having a fifth cross-sectional area.

13. The reaction injection molding assembly of claim 12 wherein the second cross-sectional area of the first secondary runner equals, or at least is substantially equal to, the sum of the fourth cross-sectional area of the first tertiary runner and the fifth cross-sectional area of the second tertiary runner.

14. The reaction injection molding assembly of claim 13 wherein the fourth cross-sectional area of the first tertiary runner is equal, or at least substantially so, to the fifth cross-sectional area of the second tertiary runner.

15. The reaction injection molding assembly of claim 10 further comprising:
a diverging fan gate in communication with the first molding chamber and disposed upstream thereof, the fan gate defining a cross-sectional area and a flow length;
wherein the cross-sectional area of the fan gate is substantially constant across the flow length of the fan gate.

16. The reaction injection molding assembly of claim 15 wherein the fan gate diverges at a fan gate angle within the range of from about 20° to about 175°.

17. The reaction injection molding assembly of claim 15 wherein the fan gate intersects the first molding chamber to thereby define a material flow front included angle ranging from about 5° to about 180°.

18. The reaction injection molding assembly of claim 17 wherein the material flow front included angle is in the range of from about 45° to about 165°.

19. The reaction injection molding assembly of claim 10 further comprising:
a fourth molding chamber sized to receive a golf ball precursor product;
wherein the plurality of flow channels also provide flow communication between the inlet and the fourth molding chamber.

20. A process for producing a golf ball by reaction injection molding, the process comprising:
providing a molding member comprising,
an inlet,
a molding chamber sized to receive a golf ball core or intermediate golf ball assembly,
a diverging fan gate in communication with the molding chamber and disposed upstream thereof, the fan gate defining a cross-sectional area and a flow length, and
a flow channel providing communication between the inlet and the fan gate; wherein the cross-sectional area of the fan gate is constant or at least substantially so, across the flow length of the fan gate;
positioning a golf ball core or intermediate golf ball assembly in the molding chamber; and
introducing flowable molding reactants into the molding chamber that undergo reaction to thereby form the golf ball.
